(19) United States
(12) Patent Application Publication
(10) Pub. No.: US 2006/0065285 A1
(43) Pub. Date: Mar. 30, 2006

(54) Rust prevention cleaning process apparatus and method thereof for a continuously variable transmission belt

(75) Inventor: Kiyozumi Takahashi, Shizuoka-shi (JP)

Correspondence Address: BLANK ROME LLP, 600 NEW HAMPSHIRE AVENUE, N.W., WASHINGTON, DC, 20037, US

(73) Assignee: JATCO Ltd., Fuji-shi (JP)

(21) Appl. No.: 11/235,209

(22) Filed: Sep. 27, 2005

(30) Foreign Application Priority Data
Sep. 30, 2004 (JP) 2004-286963

(51) Int. Cl. B08B 3/12

(52) U.S. Cl. 134/1

(57) ABSTRACT

A rust prevention cleaning process apparatus for a Continuously Variable Transmission (CVT) belt comprising an oil tank filled with rust protection cleaning oil suitable for rustproof cleaning of a CVT belt and an ultrasonic excitation module for performing ultrasonic excitation of the rust prevention cleaning oil. Then, rust preventive oil is spread on the attached surfaces of a CVT belt for a short period of time to acquire a sufficient rustproofing effect.

### BACKGROUND OF THE INVENTION

1. Field of the Invention

The present invention relates to a rust prevention cleaning process apparatus and a rust prevention cleaning process method used for a Continuously Variable Transmission (CVT) belt (hereinafter denoted as a “CVT belt”).

2. Description of the Related Art

FIGS. 4A and 4B are outline view diagrams of a CVT belt in conventional prior art. As shown in these diagrams, a CVT belt 1 is constructed by assembling two laminated belts 2 containing a plurality of metal rings 2a (for example, a stack of about 12 endless layers) which are supported by thin trapezoidal layered elements 3 composed of a large number of metal elements 3a (for example, about 400 consecutive steel elements).

Each of the metal elements 3a consists of a small piece of metal punch processed from a metal plate and molded into a specified shape. The specified shape, for example, is similar to the physical form of the upper-half image of a human body. Specifically, a metal element 3a resembles a molded shape having a head portion 3b and a chest portion 3c, along with a neck portion 3d which connects between the head portion 3b and the chest portion 3c. Additionally, a protrusion 3e (raised circular knurl) is formed in one direction of the surface side (front surface as seen in FIG. 4B) of the head portion 3b and a cavity 3f (circular indent) is formed in the same location on the opposite direction surface side (rear surface of drawing). Alignment of the metal elements 3a is accomplished by consecutively inserting the protrusion 3e into the cavity 3f of the adjoining metal elements 3a.

Two laminated belts 2 are inserted in the recessed parts 3g (belt grooves) formed between the head portion 3b and the chest portion 3c of the metal elements 3a, respectively. Here, when the gap (the space clearance width of the recessed parts 3g) between the head portion 3b and the chest portion 3c is defined as “L” (refer to FIG. 4B), the number of stacked layers for the laminated belts 2 is set so that the lamination thickness “D” for each of the laminated belts 2 (refer to FIG. 4A) constitutes nearly “L” of an equivalent or slightly smaller value.

After assembling a CVT belt 1 as described above in the construction of a metal pushing type V-belt CVT, each CVT belt 1 is immersed in lubricating oil (transmission fluid). Thus, there is no need to be concerned about the occurrence of rust.

Apart from that, in many cases a CVT belt 1 is not immediately mounted into a V-belt continuously variable transmission following manufacture and installed after a considerable period of time. Also, as a required number of the CVT belt 1 are typically placed in manufacture storage beforehand, rust may be generated on each part of the CVT belt 1 during this period. For this reason, rust prevention (anti-corrosion) treatment of the CVT belt 1 is essential, for example, immersing an assembled CVT belt 1 in an oil tank and agitating the belt within the oil tank to prevent occurrence of rust until mounted in a V-belt continuously variable transmission.

However, in order to acquire a sufficient rustproofing effect in a CVT belt 1 by immersing an assembled CVT belt 1 in an oil tank and agitating the belt within the oil tank, there is a problem of this procedure requiring a considerable amount of time.

Basically, the laminated belts 2 are an integral part of a CVT belt 1 with each containing a stacked layer of a plurality of metal rings 2a (for example, about 12 endless layers) in a laminated state. Also, the layered elements area second integral part containing a stacked layer of a plurality of the metal elements 3a (for example, about 400 elements) in an aligned state. For that reason, rust preventive oil cannot easily permeate the attached surfaces between the laminated belts 2 and the layered elements 3. Furthermore, at the time of assembly of a CVT belt 1, chlorides, such as, sweat (perspiration), etc. may adhere to the surface of the metal rings 3a construction of the two laminated belts 2 or the metal elements 3a construction of the layered elements 3. As mentioned above, “rust preventive oil cannot easily permeate” these attached surfaces and it is not a simple task to flush away such chlorides with rust preventive oil. Regarding this matter (chloride residue), these parts need to be immersed for a considerable amount of time in an oil tank and agitated within the oil tank.

### SUMMARY OF THE INVENTION

Therefore, the present invention has been made in view of the circumstances mentioned above. Accordingly, the object of the present invention is provide a rust prevention cleaning process apparatus and a rust prevention cleaning process method for a Continuously Variable Transmission (CVT) belt which is capable of spreading rust preventive oil on the attached surfaces of a CVT belt for acquiring a sufficient rustproofing effect, as well as be able to readily flush away chlorides, such as sweat, etc. adhered to these attached surfaces.

The rust prevention cleaning process apparatus for a CVT belt related to the present invention comprises an oil tank filled with rust protection cleaning oil suitable for rustproof cleaning of a CVT belt and an ultrasonic excitation module for performing ultrasonic excitation of the rust prevention cleaning oil.

As a preferred embodiment of the present invention, the rust prevention cleaning process apparatus for a CVT belt provides an elastic material between the oil tank and the oil tank mounting surfaces.

Additionally, the rust prevention cleaning process method for a CVT belt related to the present invention comprises the steps of filling an oil tank with rust prevention cleaning oil for rustproof cleaning of a CVT belt and immersing the CVT belt in the rust prevention cleaning oil while performing ultrasonic excitation of the rust prevention cleaning oil.

According to the present invention, ultrasonic excitation of the rust prevention cleaning oil is used for rust prevention cleaning of a CVT belt. In this manner, the impulse force of the rust prevention cleaning oil cavitation generated following that excitation fully permeates not only the surface of a CVT belt, but also each part of the attached surfaces. As a result, this procedure can be carried out without exhaustive cleaning and rustproofing of all parts of the attached surfaces and is capable of readily removing chlorides, such as sweat, etc. by that impulse force.

Furthermore, by providing an elastic material between the oil tank and the oil tank mounting surface, the excitation force of the ultrasonic excitation module is isolated by an elastic material and conveyed to the mounting surface of the oil tank. Thus, loss of ultrasonic excitation energy can be eliminated.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a conceptual structure view of the rust prevention cleaning process apparatus for a CVT belt in the preferred embodiment of the present invention;

FIG. 2A is a configuration diagram of the ultrasonic excitation module 13;

FIG. 2B is a diagram for explaining cavitation;

FIG. 3A is a diagram showing the cleaning and rustproofing effect in each part of the CVT belt 1 attached surfaces;

FIG. 3B is a diagram showing the cleaning and rustproofing effect in each part of the CVT belt 1 attached surfaces;

FIG. 3C is a diagram showing the cleaning and rustproofing effect in each part of the CVT belt 1 attached surfaces; and

FIG. 4 is an outline view of a conventional prior art CVT belt.

### DETAILED DESCRIPTION OF THE PREFERRED EMBODIMENTS

Hereinafter, the preferred embodiments of the present invention will be described in detail with reference to the drawings.

Additionally, illustration of specific or example numerical values for various details in the following explanation or character strings and other symbols are merely references for a clear understanding of the concept of the present invention. Accordingly, the concept of the present invention should not be limited explicitly to this terminology entirely or in part.

Furthermore, explanation has been omitted which describes details of well-known methods, well-known procedures, well-known architecture, well-known circuit configurations, etc. (hereinafter denoted as “common knowledge”) for the purpose of a concise explanation, but does not intentionally exclude this common knowledge entirely or in part. Therefore, relevant common knowledge already known by persons skilled in the art at the time of filing the present invention is naturally included in the following description.

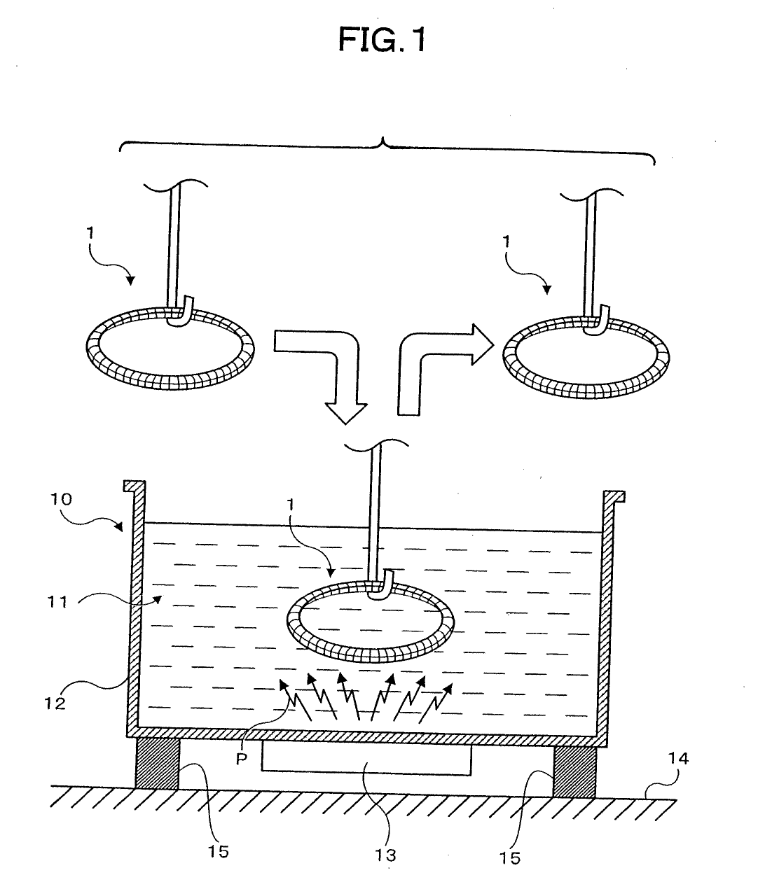

FIG. 1 is a conceptual structure view of the rust prevention cleaning process apparatus for a CVT belt in the preferred embodiment.

As seen in the drawing, a rust prevention cleaning process apparatus 10 for a CVT belt comprises an oil tank 12 fully filled with rust prevention cleaning oil 11 (for example, transmission oil for a CVT belt) suitable for rust prevention cleaning of a CVT belt 1; an ultrasonic excitation module 13 for performing ultrasonic excitation of the oil tank 12 wall surface (in FIG. 1, the bottom wall surface and even in a side wall surface is acceptable); and an elastic material 15, such as rubber, spring, etc., formed between the oil tank 12 and the mounting surface 14 (floor surface, etc.) in order not to propagate sound pressure energy P in the ultrasonic excitation module 13.

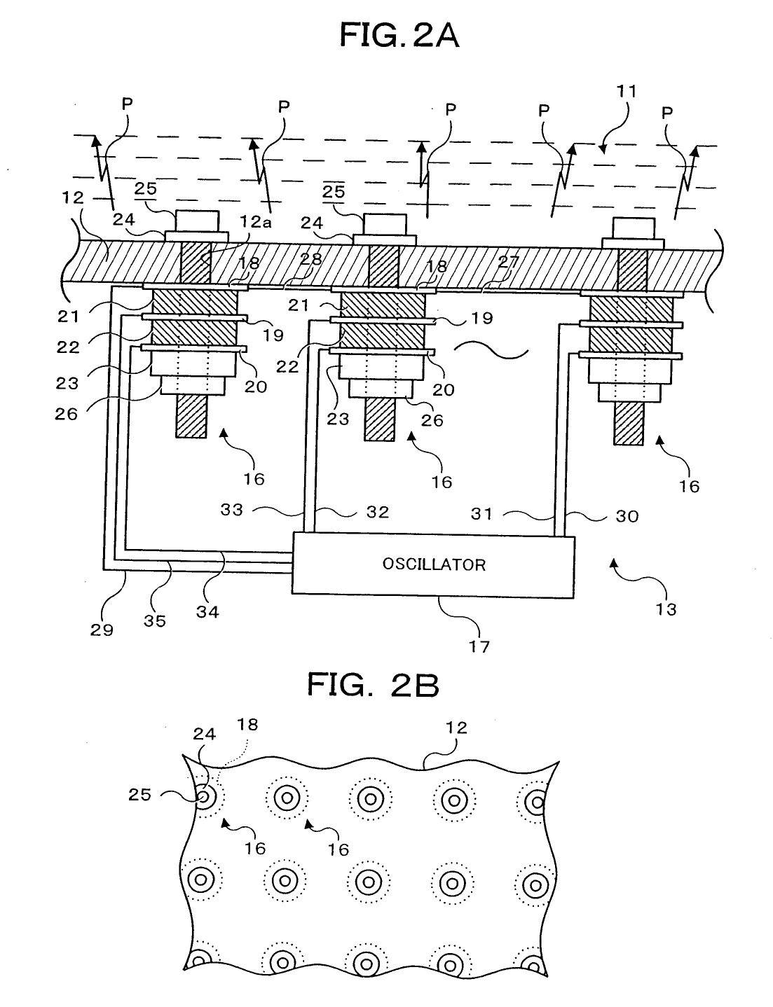

FIG. 2A is a configuration diagram of the ultrasonic excitation module 13. In FIG. 2A, the ultrasonic excitation module 13 configuration has a plurality of ultrasonic transducers 16 mounted in matrix form on the oil tank 12 wall surface; and an oscillator 17 for driving the ultrasonic transducers 16.

Each of the ultrasonic transducers 16, for example, can be applied as a Langevin type (Paul Langevin) structure combined mechanically with an electrostriction element (PZT (lead zirconium titanate): also known as piezoelectric crystals or a piezoelectric device).

In the case of a Langevin type ultrasonic transducer 16, each of the ultrasonic transducers 16 comprises three electrodes (hereinafter, a 1^{st} electrode 18, a 2^{nd} electrode 19 and a 3^{rd} electrode 20), two toric (circular) electrostriction elements (hereinafter, a 1^{st} electrostriction element 21 and a 2^{nd} electrostriction element 22) composed of ceramic, for example, lead zirconium titanate (PbZrO₃, PbTiO₃), etc. and a metal block 23. Each of these parts forms a stacked layer in a predetermined sequence (sequential order of the 1^{st} electrode 18, the 1^{st} electrostriction element 21, the 2^{nd} electrode 19, the 2^{nd} electrostriction element 22, the 3^{rd} electrode 20 and the metal block 23). The layered transducer is consecutively formed with a bolt 25 inserted in a hole 12a drilled in the wall surface of the oil tank 12 in matrix form via a packing 24 for liquid leakage prevention, which is unified by fastening a nut 26 at needed torque and mounted on a wall surface of the oil tank 12.

The 1^{st} electrode 18 of all the ultrasonic transducers 16 is connected to the oscillator 17 via common signal lines 28, 29. The 2^{nd} electrode 19 and the 3^{rd} electrode 20 of each of the ultrasonic transducers 16 are connected to the oscillator 17 via individual signal lines 30-35, respectively.

In such a configuration, for example, the oscillator 17 generates driver voltage having a repetition frequency of about several 10's of kHz (10 kHz to 100 kHz). When this driver voltage is applied between the individual wiring 30-35 and common wiring 28, 29, by the piezoelectric effect as seen in FIG. 2B (The physical dimension phenomenon when applying an electric field to a piezoelectric crystal, namely, the positive and negative ion charge centers are displaced from uniformly distributed positions. This effect, also known as converse piezoelectricity, generates elastic changes and shifting deformations.), the 1^{st} electrostriction element 21 and the 2^{nd} electrostriction element 22 of each of the ultrasonic transducers 16 pulsate at the appropriate frequency. This pulsating (vibration) is conveyed to the rust prevention cleaning oil 11 via the wall surfaces of the oil tank 12 and, ultimately, the generated cavitation propagates the sound pressure energy P within the rust prevention cleaning oil 11 fluid.

When an assembled CVT belt 1 as shown in FIG. 1 is immersed in the rust prevention cleaning oil 11 while generating such cavitation, this CVT belt 1 will be bombarded by the impulse force of cavitation carrying the sound pressure energy P. Accordingly, in addition to the CVT belt 1 surface being cleansed and rustproofed with the rust prevention cleaning oil 11, as the above-mentioned impulse force also readily permeates the attached surfaces of each part of the CVT belt 1, merely the CVT belt 1 only has to be immersed in the oil tank and agitated in the oil tank. Also, as described earlier with regard to the attached surfaces in conventional prior art which require a considerable amount of time to acquire a cleansing effect and rustproofing effect, the present invention can acquire a superb cleansing effect and rustproofing effect in a much shorter period of time.

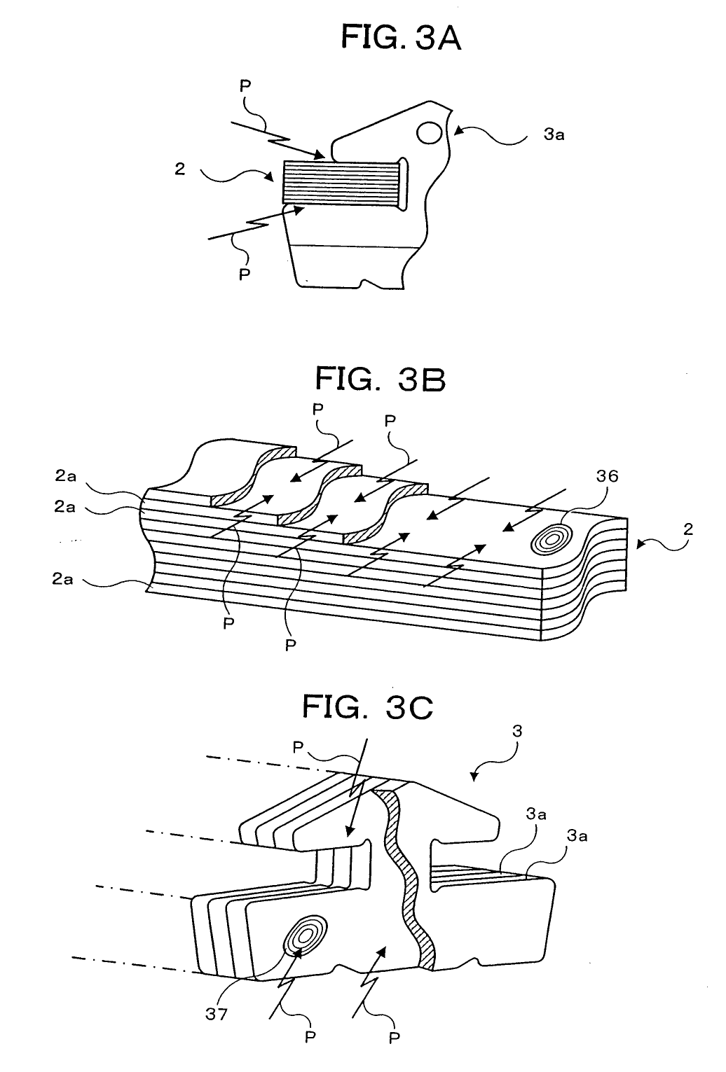

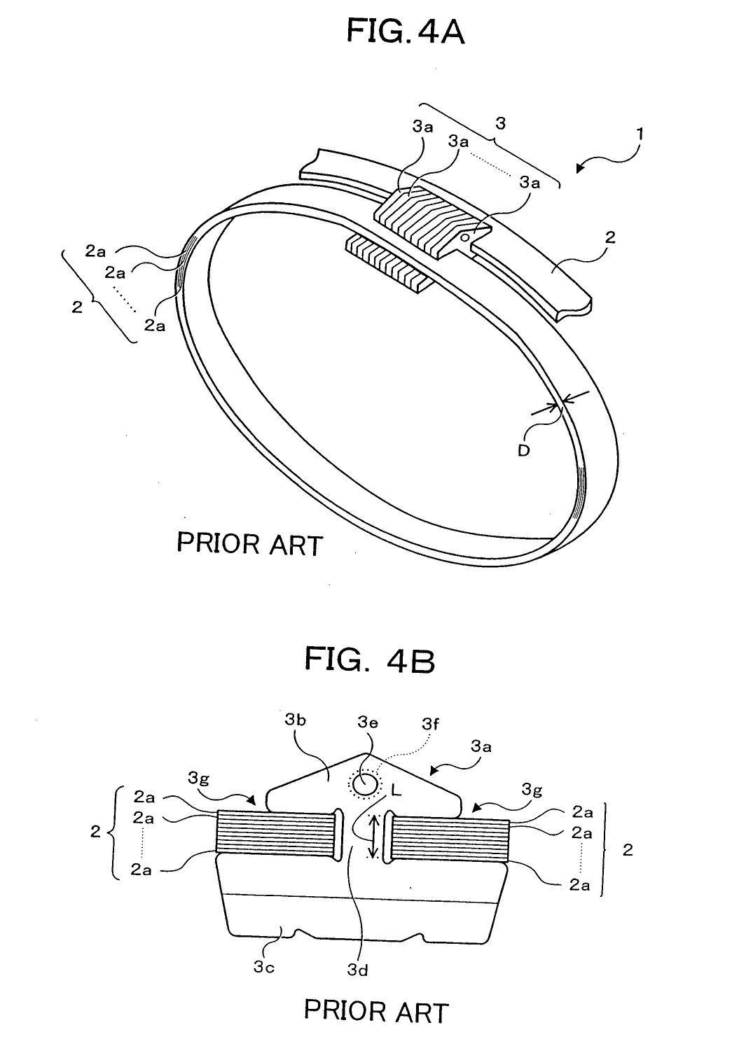

FIGS. 3A-3C are diagrams showing the cleaning and rustproofing effect in each part of the CVT belt 1 attached surfaces. As seen in these drawings, the attached surfaces of each part of the CVT belt 1 are the following three places. Specifically, as illustrated in FIG. 3A, the 1^{st} attached surfaces are the contact surfaces of the metal elements 3a and the laminated belts 2. As illustrated in FIG. 3B, the 2^{nd} attached surfaces are the associated contact surfaces of each of the metal rings 2a configuration of the laminated belts 2. As illustrated in FIG. 3C, the 3^{rd} attached surfaces are the contact surfaces of each of the metal elements 3a configuration of the layered elements 3.

Since all of these contact surfaces are in an attached state, if accomplished like the conventional prior art, when the CVT belt 1 is merely immersed in the oil tank and only agitated in the oil tank, the fluid does not permeate easily and requires a lengthy time interval for acquiring the necessary cleansing effect and rustproofing effect. In the preferred embodiment of the present invention, because the generated cavitation propagates the sound pressure energy P in the rust prevention cleaning oil 11, even if the constituent parts contain such attached surfaces, the rust prevention cleaning oil 11 can be readily permeated within a short period of time.

In addition, even in cases where chlorides, such as sweat, etc. (refer to FIGS. 3B, 3C fingerprint 36, 37, respectively), adhered to any part of the CVT belt 1, these man-made secretions can easily be removed by the impulse force of cavitation. Thus, with the removal of these chlorides a more effective rust prevention treatment effect is also required.

In the above-mentioned preferred embodiment, although the Langevin type ultrasonic transducer 16 is used, the present invention is not limited to this. For example, the present invention may use an ultrasonic transducer of a resonance block type, immersion type and other formats. Additionally, the mounting location of the ultrasonic transducers 16 is not restricted to the wall surfaces of the oil tank 12. The mounting location only has to be in a position capable of generating cavitation of the required sound pressure energy in the rust prevention cleaning oil 11 filled in the inner part of the oil tank 12.

While the present invention has been described with reference to the preferred embodiments, it is intended that the invention be not limited by any of the details of the description therein but includes all the embodiments which fall within the scope of the appended claims.

What is claimed is:

1. A rust prevention cleaning process apparatus for a Continuously Variable Transmission (CVT) belt comprising:
an oil tank filled with rust protection cleaning oil suitable for rustproof cleaning of a CVT belt; and
an ultrasonic excitation module for performing ultrasonic excitation of said rust prevention cleaning oil.

2. The rust prevention cleaning process apparatus for a CVT belt according to claim 1, wherein an elastic material is provided between said oil tank and said oil tank mounting surfaces.

3. A rust prevention cleaning process method for a Continuously Variable Transmission (CVT) belt comprises the steps of:
filling an oil tank with rust prevention cleaning oil for rustproof cleaning of a CVT belt; and
immersing said CVT belt in said rust prevention cleaning oil while performing ultrasonic excitation of said rust prevention cleaning oil.
